(19) United States
(12) Patent Application Publication
(10) Pub. No.: US 2008/0305008 A1
(43) Pub. Date: Dec. 11, 2008

(54) Micro-Fluidic Structures

(75) Inventors: Mark Hyland, Oxfordshire (GB); Peter Kevin Stephenson, Oxfordshire (GB); Florent Francois Marie Crepineau, Oxfordshire (GB)

Correspondence Address: FULWIDER PATTON LLP, HOWARD HUGHES CENTER, 6060 CENTER DRIVE, TENTH FLOOR, LOS ANGELES, CA, 90045, US

(73) Assignee: OXFORD BIOSENSORS LIMITED, Oxfordshire (GB)

(21) Appl. No.: 12/158,293

(22) PCT Filed: Dec. 20, 2006
(86) PCT No.: PCT/GB2006/004802

§ 371 Date: Jul. 29, 2008

(30) Foreign Application Priority Data
Dec. 21, 2006 (GB) 0525997.3

(51) Int. Cl. B01J 19/00; B01L 11/00; B01L 3/00; G01N 27/26

(52) U.S. Cl. 422/68.1; 422/99; 422/101; 422/102; 204/400

(57) ABSTRACT

A micro-fluidic structure such as a bio-sensor device has a dispensing element for fluid and a destination zone in communication with, and downstream of, the dispensing element. A bridge structure extends to the dispensing element and promotes fluid passage across the bridge structure from the dispensing element toward the destination zone.

The present invention relates to micro-fluidic structures.

Micro-fluidic structures are used in various applications and include micro-fluidic structures for use in devices for sampling and testing of fluids, particularly, but not exclusively biological fluids. For example the invention has particular utility in micro-fluidic structures for devices used in medical diagnostic techniques, such as, for example, bio-sensor devices.

WO03/056319 discloses an electrochemical micro-electrode bio-sensor device having an array of wells or other sites which is used for analysing fluids including biological fluids (for example blood) or non biological fluids. The arrangement disclosed requires the fluid to be screened to be delivered to the one or more wells or other sites to be analysed and an electrical output produced. The quantities of fluid delivered for screening are at the level of micro litre volumes. A further example of a micro-electrode sensor for use in bio applications is disclosed in US2005/0072670.

An improved micro-fluidic structure for use in micro-fluidic techniques has now been devised.

According to a first aspect, the present invention provides

a micro-fluidic structure comprising:
a dispensing element for dispensing fluid,
a destination zone in communication with, and downstream of, the dispensing element; and,
a bridge structure extending to the dispensing element and promoting fluid passage across the bridge structure from the dispensing element toward the destination zone.

The bridge structure locally bridges to the dispensing element and/or the fluid present on the facing surface of the dispensing element. This permits or accelerates passive flow of the fluid (for example plasma) into the downstream portions of the structure. In a preferred embodiment the dispensing element may comprise a red blood cell separation membrane and the invention enables plasma on the bottom of the membrane to flow off because there is bridging contact via the bridge structure. When the bridge is locally created it propagates to substantially the entire adjacent surface area of the dispensing element by capillary force, allowing free flow of fluid. In the absence of the bridge structure the fluid will coat the bottom surface of the dispensing element in its lowest energy configuration and flow may not be induced (other than by application of other force delivery means, such as for example applied pressure).

It is preferred that the bridge structure includes a bridge surface, the bridge surface preferably being hydrophilic. Beneficially, the bridge surface comprises a hydrophilic film or layer so that the solution will preferentially wet the bridge structure giving a lower interfacial energy between the solution and the bridge than between the solution and the underside of the dispensing element.

Desirably the bridge has an apex or zenith proximate the dispensing element. In one embodiment the bridge has a convex bridge surface, and may for example have a part spherical surface such as a hemispherical surface. Curved, rather than stepped change edges and surfaces improves flow and are less hydrophobic.

Preferably a fluid flowpath extends downstream of the dispensing element. In a preferred embodiment the fluid flowpath comprises a capillary flowpath. Beneficially the fluid flowpath is a micro fluid flowpath having the capacity to transport micro litre volumes of fluid. Beneficially, where the capillary flowpath includes circular section channels, the diameter of the channels is preferably in the range 0.1 mm to 5 mm (more preferably in the range 1.5 mm to 2.5 mm). Alternatively channels having a rectilinear or other geometry section may be used, beneficially having a side dimension in the range 0.001 mm to 3 mm (more preferably in the range 0.05 mm to 1 mm). The downstream flowpath may comprise a plurality of flowpaths such as a plurality of connected capillary flowpaths. The connection may be dendritic. In a certain embodiment the surface of the bridge structure may be contoured to promote flow along certain pre-defined paths. For example, this would promote flow to specific downstream flowpaths. The contour of the bridge structure surface may comprise a sloped or valley path.

It is preferred that the dispensing element comprises a receiver element arranged to hold a volume of fluid. Beneficially the receiver element is fluid permeable. The receiver element preferably acts to filter fluid. In a preferred embodiment the receiver element acts to filter a biological fluid, preferably filtering blood and permitting plasma to pass. In a preferred embodiment the dispensing element comprises a membrane. Beneficially the membrane is arranged such that a fluid sample is deposited on an obverse side of the membrane and dispensed via a reverse side.

In one embodiment, the bridge structure may be configured to contact the dispensing element.

Alternatively, the bridge structure may be configured to be spaced from the dispensing element, by a small gap, substantially in the range 1 μm to 30 μm.

The required height of the bridge structure (i.e. the spacing from the dispensing element) depends upon the fluid passing via the dispensing element and consequently the surface tension of a hanging drop of the fluid. This in turn depends upon the viscosity of the fluid, the surface tension of the dispensing element (and pore size of the dispensing element). The amount of time the fluid takes to pass through the dispensing element (the dwell time) can be controlled by varying the spacing between the bridge and the dispensing element.

Beneficially, the destination zone comprises a destination station containing a reagent substance for reacting with the fluid delivered from the dispensing element. The reagent substance may comprise, for example, an electro-active substance.

In a specific embodiment, the destination zone may comprise a plurality of destination stations, respective stations containing a respective reagent substance for reacting with the fluid delivered from the dispensing structure. In such an embodiment, separate destination stations contain different respective reagent substances. The separate destinations may be served via separate delivery channels, as described above.

In a specific embodiment, a respective destination zone may comprise a well. Beneficially a micro-fluidic capillary flowpath communicates with the respective well preferably via a connection at the bottom of the well. In a specific embodiment, the destination zone may comprise an array of wells, the structure preferably including a micro fluid capillary flowpath network leading to the array of wells.

In an alternative embodiment, the micro-fluidic capillary flowpath communicates with the respective well preferably via a connection at the top of the well.

Such specific embodiments described would be conveniently suitable for use in devices and structures such as those disclosed in WO03/056319 in which an electro-chemical micro-electrode sensor may have an array of wells or other sites which is used for analysing fluids including biological fluids (for example blood) or non biological fluids.

The utilisation of the bridge structure, and the consequent promotion of flow of fluid from the dispensing element allows the fluid to be delivered via the downstream flowpath, to the destination zone as a discrete wave of fluid rather than a trickle effect. This ensures more uniform and simultaneous delivery to the destination zones, particularly where delivery to a plurality of destination zones is required.

In a preferred specific embodiment, the structure of the invention comprises a test strip device having the dispensing element proximate a first end thereof and the destination zone proximate a second end thereof and a micro fluid capillary flowpath extending between the dispensing element and the destination zone.

In the embodiments primarily described, the sample fluid is applied to a dispensing element and the sample passes to a reservoir below and then into a capillary channel flowpath. This enables a large surface area (separation membrane) to filter, for example blood with less hematocrit dependence than prior art lateral delivery/separation systems. Faster separation/third passage is also achieved.

The invention will now be further described, by way of example only, and with reference to the accompanying drawings, in which:

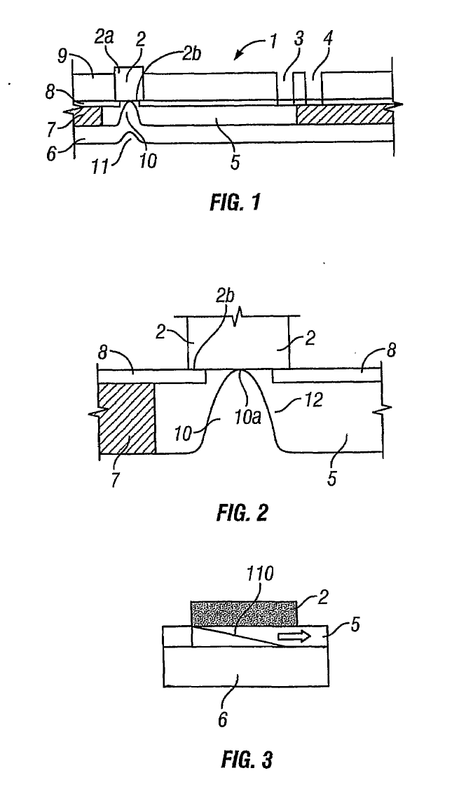

FIG. 1 is a schematic sectional view of a first embodiment of micro-fluidic structure in accordance with the invention;

FIG. 2 is a detail view of a part of the structure of FIG. 1;

FIG. 3 is a schematic view of a sloped surface embodiment of bridge structure;

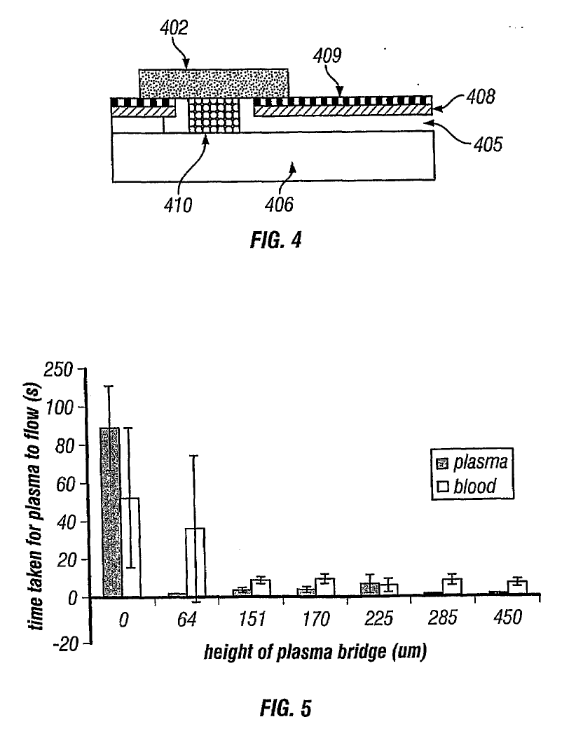

FIG. 4 is a schematic view of an alternative embodiment of micro-fluidic structure in accordance with the invention;

FIG. 5 is a graph showing the results of tests conducted using the structure of FIG. 4;

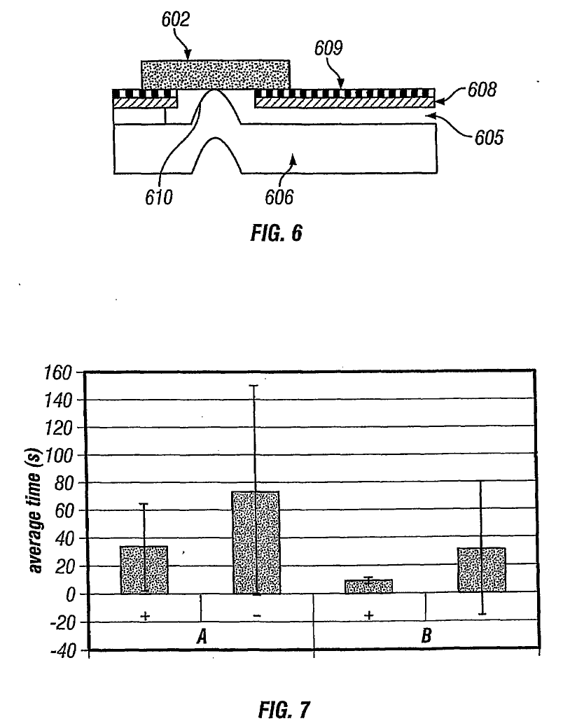

FIG. 6 is a schematic view of a further alternative structure in accordance with the invention; and

FIG. 7 is a graph showing the results of tests conducted using the structure of FIG. 6.

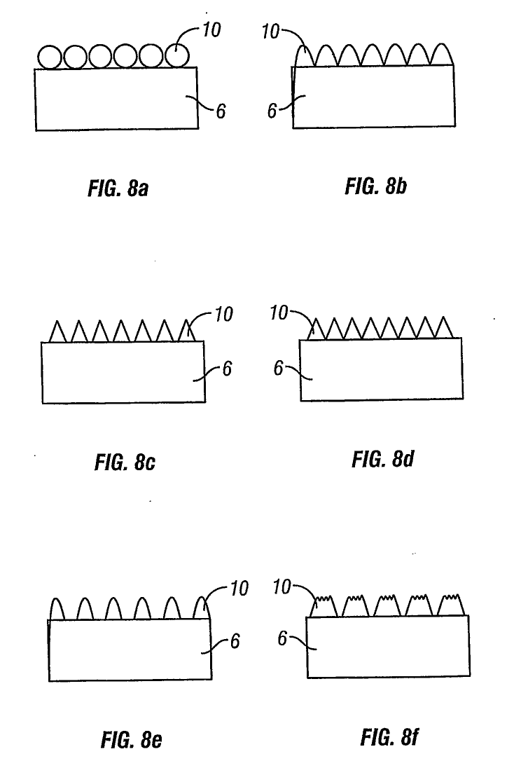

FIG. 8 shows alternative embodiments of bridge structure in accordance with the invention; and

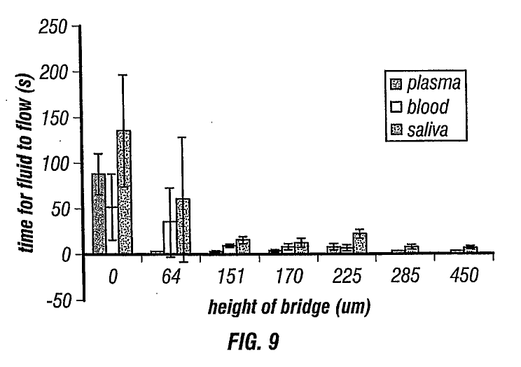

FIG. 9 shows the flow rate for saliva, plasma and blood through a separation membrane for varying bridge spacing/height.

Referring to the drawings and initially to FIG. 1, there is shown a bio-sensor device in the form of a micro-fluidic device comprising a biological fluid sample screening strip 1. The strip 1 may be of a variety including a microband electrode electrochemical sensor, constructed in the same or similar fashion to sensors of the type disclosed in for example WO03/056319. For ease of reference, in this description, the sensor electrodes are not indicated in the drawings, in order to more clearly identify the micro-fluid flowpaths and the arrangement embodying the concept of the invention.

In the arrangement shown in FIG. 1 a blood separation membrane 2 acts as a dispensing element to dispense plasma into a micro-fluid capillary flowpath 5 which extends to connect with an array of wells, two of which (3,4) are shown in the drawings. The strip is formed of a series of layers including a hydrophilic layer 6, a layer of spacer tape 7 including, integrally formed, the micro-fluid capillary flowpath 5 which is typically of rectilinear section having side dimensions of 500 μm and 100 μm. Examples of suitable separation membranes 2 are those commercially available from Whatman under the trade designations VF1, VF2 and GFD or BTS membrane available from PALL.

Above the spacer layer 7 is a sealing layer 8 including apertures defining the lowermost portions of wells 3, 4 and an aperture below the blood separation membrane 2. The sealing layer 8 may be a plastics material and for example of polyethylene terepthalate (PET) or polycarbonate (PC) and typically coated on one side with a pressure sensitive or heat sensitive adhesive layer. The spacer tape 7 is typically plastics (for example of PET or PC) and maybe coated on both sides with either a pressure sensitive or heat sensitive adhesive layer. The hydrophilic layer 6 may be of plastics (for example PET or PC) and may be coated on one side with pressure sensitive or heat sensitive layer with a mixed in surfactant. Acrylic based adhesives may be used as either pressure or heat sensitive adhesives. It will be readily appreciated that the layer structure and materials described are exemplary only and other materials or structures may usefully be utilised and fall within the scope of the invention.

Above the sealing layer 8 is the upper layer structure 9 of the strip comprising electrochemical cell layer structure of the strip. This upper electrochemical cell layer structure is not described in detail herein, but exemplary structures are disclosed in WO/03/056319. An aperture defining a receiving station for the blood separation membrane 2 is defined through the upper layer structure 9, as are apertures defining the upper portions of the wells 3,4. Preferably, the wells 3,4 have diameters of about 0.8 to 1.0 mm. Well diameters of 0.1 mm to 5 mm may be utilised dependent upon a particular application. Where non circular wells are used, the length or width dimension will typically be in the range 0.1 mm to 5 mm (more typically 0.9 to 1 mm). Typically the well depth will be in the range 50 μm to 1000 μm, more typically 200 μm to 800 μm, most typically 300 μm to 600 μm.

An electro-active substance is contained within the wells 3,4. The electro-active substance 8 is freeze dried to form a porous cake. On introduction of a measurement sample of plasma (as described henceforth) into the wells 3,4 the electro-active substance dissolves and an electrochemical reaction may occur and measurable current, voltage or charge may occur in the cell. Electro-active substances are discussed in more detail in, for example WO 03/056319.

The micro-fluid capillary flowpath 5 connects via apertures in the sealing layer to the wells 3, 4 and also the blood separation membrane 2. A blood sample is deposited on the obverse side 2a and the membrane 2 filters the blood such that filtered plasma emerges at the reverse side 2b of the membrane. The plasma passes into the capillary flowpath 5 and enters into the wells 3, 4 at the respective bases of respective wells. Typically the volume of the plasma passing into the system is a microlitre volume, typically within the range 0.2 μL to 30 μL.

It is difficult to promote flow of plasma from the separation membrane 2 into the capillary flowpath 5, gravitational force generally being insufficient. In accordance with the present invention a bridge structure 10 is positioned at the head of the capillary flowpath 5 and immediately adjacent the downstream side of the separation membrane 2. In the embodiment shown the bridge structure 10 is a dimple formed by indentation 11 on the reverse side of the hydrophilic layer 6.

The purpose of the bridge structure is to form a localised bridge between the micro-fluidic capillary flowpath 5 and the plasma on the adjacent reverse surface 2b of the separation membrane 2. In the embodiment shown the plasma is separated and flows along the reverse side of the membrane 2 to the dimple. The plasma then flows down the dimple 10 and fills the capillary channel 5. The bridge structure dimple 10 locally touches the membrane 2 initiating the plasma bridge. Once the plasma bridge is set up, it propagates to the whole reverse surface of the membrane by capillary force allowing free flow of plasma from the membrane into the head chamber 12 and thereafter into the capillary channel flowpath 5. The surface tension of the membrane 2 plasma interaction is broken by the solid hydrophilic film surface of the dimple bridge structure 10, in contact with it.

Preferred features of the bridge structure 10 are that it has a solid (preferably non porous, preferably hydrophilic) surface and that it has an apex or zenith (preferably a convex, domed, or at least part spherical) surface at the contact location with the membrane 2. Curved surfaces are preferred because stepped or slop angled surface formations tend to be hydrophobic. In the embodiment described a dimple structure 10 has been primarily described. It should be readily appreciated that other structural forms could be employed within the scope of the invention. For example hydrophilic surface plastic spheres or domed elements could be utilised, bonded to the surface of layer 6, or formed integrally at manufacture. Also, an array of dimples, spheres or domed elements could also be utilised. Furthermore, it is envisaged that non spherical (or part spherical) surface geometry structures could be usefully employed such as finger projections, sloping surfaces or other protuberances. A bridge structure having a reticulated or mesh form has also been found to work effectively in certain applications.

Also, in the embodiment shown, the apex 10a of the dimple structure 10 is in contact with the reverse side 2b of the separation membrane 2. It is however envisaged that the apex 10a could be spaced by a very small gap and achieve the same result of effectively bridging to the membrane 2, provided that the apex 10a contacts with plasma accumulating on the reverse side 2b of the separation membrane 2. It has been found that a gap in the range 1 μm to 30 μm enables the invention to work effectively. Indeed by controlling the gap for specific fluids, it is possible to control the flow of fluid through the separation membrane 2 and from the separation membrane 2 into the downstream capillary flowpath 5. The necessary spacing of the apex 10a from the membrane 2 depends upon the surface tension of the passing fluid (which hangs in drop-form from the underside of the separation membrane 2). This in turn depends upon the viscosity of the passing fluid, the surface tension of the membrane, the pore size of the membrane, and other factors.

Additionally, the dwell time of the fluid in the membrane may be controlled by the spacing distance of the apex 10a of the bridge structure 10 from the underside 2a of the membrane 2. For example, with a lectin impregnated glass fiber doped membrane (eg., GFD-VF2 from Whatman), it is required to retain the fluid sample within the membrane for a few seconds in order to allow time for the lectins to work. A spaced bridge apex 10 a means that a drop takes several seconds to reach the required size to cross the bridge gap.

If the bridge structure dimple 10 is not present the flow of plasma into the capillary channel is dependent solely upon the pull of gravity, which is not large enough to overcome the surface tension interaction between the plasma and the membrane 2. In such circumstances the plasma will not flow. Centrifuge systems or applied pressure devices may be used to overcome this but such arrangements make systems more complex. The bridge system of the present invention allows the wells 3, 4 to fill in a discrete pulse or wave of fluid which makes it more likely that the wells will fill at the same time.

It is possible to further control the form of the surface of the bridge structure in order to control the characteristics of flow of the fluid. For example, and with reference to FIG. 3, it is possible to have a slope form hydrophilic bridge surface 110. This can be used to direct, preferentially, the fluid from the membrane 102 into the capillary channel 105 (in a direction to the right in FIG. 3, for example). Alternatively, a curve form bridge structure may be provided with valleys or channels extending downwardly away from the apex to direct flow into selected channels for onward delivery to a series of wells, 3, 4.

Other bridge form arrangements are shown in FIGS. 8a to 8f. Each of the structures 8a to 8f is shown in transverse cross section. In the arrangement of FIG. 8a a plurality of spheres 10 (for example spherical glass balls) are mounted on the base layer 6 to form the bridge. The apexes of the balls 10 form the apex bridge surfaces and the fluid passes under capillary action downstream of the balls 10. The other arrangements each include an array of apexes 10 of different geometrics and profiles present on the base layers 6.

In order to further exemplify the present invention, experiments were conducted to better identify important characteristics.

### Experiment 1

A first test strip was produced in accordance with the exemplary embodiment shown in FIG. 4. In this embodiment, the separation membrane structure 402 comprises Whatman VF2 fibre glass membranes soaked in 80 μg/ml of lectin solution and dried over night in a fume cupboard. A plasma bridge 410 was constructed of 2 mm diameter circles of monofilament nylon mesh (NITEX 225/42, produced by SEFAR) placed into the test strip at the centre of a 4 mm hole in the hydrophilic sealing layer 408. The lectin separation membrane structure 402 was adhered to the adhesive layer 409 covering the hydrophilic sealing layer 402 and a 2 Kg weight was applied to the membrane for 5 s.

Venous blood was drawn into a Li:Heparin coated vacutainer which was then kept agitated and discarded after 3 hours. 60 μl of blood was then pipetted onto the blood separation membrane 402. The time taken between applying the blood sample and for plasma to appear in the capillary channel 405 was measured using a stopwatch by observation in a microscope.

Varying heights of plasma bridge 410 (and consequently varying separation distances between the bridge 410 and the underside of the membrane 402) were investigated and 5 repeats were measured at each height. The effect of the plasma bridge height on the time taken for plasma flow from whole blood was determined. The depth of the reservoir into which the plasma flowed was 180 um in each case. A second test was performed by applying plasma to the VF2 membrane 402 in place of whole blood. The time taken for plasma to enter the channel was recorded in the same way as for whole blood. Results are summarised in FIG. 5.

### Experiment 2

A second test strip was produced in accordance with the exemplary embodiment shown in FIG. 6. In this embodiment, the separation membrane structure 602 used was a lectin coated Whatman VF2 blood separation membrane as used in the embodiment of FIG. 4. A 180 μm high dimple form bridge 610 was made in the substrate 606 in the place of the NITEX bridge of the embodiment of FIG. 4.

60 μl of whole blood was applied to the VF2 membrane and the time taken for plasma to appear in the channel 605 was measured using a stopwatch. Measurements were made using the VF2 membrane both sides up and with and without the dimple plasma bridge. Results are summarised in FIG. 7.

### Experiment 3

A further test strip was produced generally in accordance with the exemplary embodiment of FIG. 6, but with the lectin coated VF2 membrane was replaced with a PALL BTS SP300 membrane.

Venous blood was drawn into a Li:Heparin coated vacutainer. Blood was kept under agitation and discarded after 3 hours. A volume of 60 μl of blood was pipetted onto the blood separation membrane 602 and the time taken for the plasma to appear was recorded using a microscope and a stopwatch. Measurements were made with or without the dimple plasma bridge 610 or with pressure applied on the membrane to initiate a contact between the membrane and the stubstate.

As can be seen from the table below, a plasma bridge is required for plasma to flow out of the BTS300 membrane in the channel.

| | | Time Between |
|---|---|---|
| | Plasma | Blood And Plasma |
| Construct | Flow | Appearance |
| BTS300 no dimple | − | >180s |
| BTS300 with | + | 27s |
| dimple | | |
| BTS300 no dimple, | + | 21s |
| contact initiated by | | |
| pressure | | |

### Experiment 4

Experiment 1 was repeated using plasma, blood and saliva as test liquids and the time taken for the fluid to flow was taken. The results are shown in FIG. 9. Each experiment was repeated 5 times and the average taken.

FIG. 9 shows the average length of time it took for fluid to flow through Nitex membrane when different heights of dimple were used. The fluids tested were blood, plasma and saliva.

The invention provides a convenient and elegant means for enabling fluid flow into capillary flowpaths or other micro-fluidic structures in circumstances where other flow propagation means would need to be utilised otherwise. The arrangement is particularly suited to sensors for biological fluid screening using micro litre fluid volumes, particularly of viscous fluids. The invention has been described and exemplified for use in bio-sensors for sampling plasma, blood and saliva. The skilled addressee will readily realise that the invention has application in other micro-fluidic devices.

1. A micro-fluidic structure comprising:
a dispensing element for fluid;
a destination zone in communication with, and downstream of, the dispensing element; and,
a bridge structure extending to the dispensing element and promoting fluid passage across the bridge structure from the dispensing element toward the destination zone.

2. A structure according to claim 1, wherein the bridge structure includes a bridge surface.

3. A structure according to claim 2 wherein the bridge surface is hydrophilic.

4. A structure according to claim 3, wherein the bridge surface comprises a hydrophilic film or layer.

5. A structure according to claim 1, wherein the bridge structure has an apex or zenith proximate the dispensing element.

6. A structure according to claim 1, wherein the bridge structure has a convex bridge surface.

7. A structure according to claim 1, wherein a fluid flowpath extends downstream of the dispensing element.

8. A structure according to claim 7, wherein the fluid flowpath comprises a capillary flowpath.

9. A structure according to claim 1 wherein the bridge structure is dimensioned to operate with micro litre fluid volumes, or less.

10. A structure according to claim 1, wherein the dispensing element comprises a receiver element arranged to hold a volume of fluid.

11. A structure according to claim 10, wherein the receiver element is fluid permeable.

12. A structure according to claim 11 wherein the receiver element acts to filter fluid.

13. A structure according to claim 12, wherein the receiver element acts to filter blood, permitting plasma to pass.

14. A structure according to claim 10, wherein the bridge structure is configured to contact the receiver element.

15. A structure according to claim 1, wherein the bridge structure is spaced from the dispensing element, by a small gap, substantially in the range 1 μm to 30 μm.

16. A structure according to claim 1, wherein the destination zone comprises a destination station containing a reagent substance for reacting with the fluid delivered from the dispensing element.

17. A structure according to claim 16, wherein the reagent substance comprises an electro-active substance.

18. A structure according to claim 1, wherein the destination zone comprises a plurality of destination stations, the respective stations containing a respective reagent substance for reacting with the fluid delivered from the dispensing structure.

19. A structure according to claim 18, wherein separate destination stations contain different respective reagent substances.

20. A structure according to claim 1, wherein the destination zone comprises a well.

21. A structure according to claim 1, wherein the destination zone comprises an array of wells.

22. A structure according to claim 20, wherein the structure includes a micro fluid capillary flowpath leading to the well.

23. A structure according to claim 1, further comprising an electrochemical electrode sensor.

24. A structure according to claim 1, wherein the dispensing element is arranged to receive a fluid sample via an obverse side and dispense fluid via a reverse side.

25. A structure according to claim 1, further comprising a test strip device having the dispensing element proximate a first end thereof and the destination zone proximate a second end thereof and a micro fluid capillary flow-path extending between the dispensing element and the destination zone.

26. A structure according to claim 1, wherein the fluid passes across the dispensing element and bridge structure in a first general direction and subsequently flows in a second direction, transverse to the first direction downstream of the bridge structure and to the destination zone.

27. A structure according to claim 26, wherein the fluid flows downwardly across the dispensing element and bridge structure, and subsequently laterally downstream of the bridge element.

28. A device including a micro-fluidic structure according to claim 1.

29. A bio-sensor device including a micro-fluidic structure according to claim 1.
